(19) United States
(12) Patent Application Publication
(10) Pub. No.: US 2014/0174078 A1
(43) Pub. Date: Jun. 26, 2014

(54) EGR SYSTEM HAVING FLOW RESTRICTING VALVE

(71) Applicant: CATERPILLAR INC., Peoria, IL (US)

(72) Inventors: Deep Bandyopadhyay, Naperville, IL (US); Michael Goetzke, Orland Park, IL (US)

(73) Assignee: CATERPILLAR INC., Peoria, IL (US)

(21) Appl. No.: 13/722,681

(22) Filed: Dec. 20, 2012

(51) Int. Cl. F02M 25/07

(52) U.S. Cl. CPC F02M 25/0787
USPC 60/605.2; 251/356; 137/2

(57) ABSTRACT

A fluid valve is disclosed for use in an exhaust system of an engine. The fluid valve may have a body and an inlet formed within the body. The inlet may have a curved first end surface with a raised convex first opening. Opposite the inlet, the fluid valve may also have an outlet formed within the body. The outlet may have a second end surface with a second opening. The fluid valve may also have a restriction formed between the first end surface and the second end surface, which connects the first and second openings.

### TECHNICAL FIELD

The present disclosure is directed to an exhaust gas recirculation (“EGR”) system and, more particularly, to an EGR system having a flow restricting valve.

### BACKGROUND

Internal combustion engines such as diesel engines, gasoline engines, and gaseous fuel-powered engines exhaust a complex mixture of air pollutants as byproducts of the combustion process. These air pollutants are composed of gaseous compounds including, among other things, the oxides of nitrogen (“NOx”). Due to increased attention on the environment, exhaust emission standards have become more stringent and the amount of NOx emitted to the atmosphere from an engine can be regulated depending on the type of engine, size of engine, and/or class of engine.

One method that has been implemented by engine manufacturers to comply with the regulation of these exhaust emissions includes utilizing an exhaust gas recirculation (“EGR”) system. EGR systems operate by recirculating a portion of the exhaust produced by the engine back to the intake of the engine to mix with fresh combustion air. The resulting mixture has a lower combustion temperature and, subsequently, produces a reduced amount of regulated pollutants.

EGR systems require a certain level of exhaust backpressure to push a desired amount of exhaust to the intake of the engine. And, the backpressure needed for adequate operation of the EGR system varies with engine load to meet emission, efficiency, and power goals. Exhaust back pressure is typically generated via a fixed restrictive orifice. An exemplary orifice is described in U.S. Pat. No. 5,188,086 to Adkins et al. (“the '086 patent”). As exhaust gas flows through the orifice at an increasing flow rate, the orifice creates a pressure differential across the intake and outlet of the valve that also increases. The orifice includes a rounded or chamfered entry forming a venturi.

Although the orifice in the '086 patent may adequately control exhaust gas recirculation in some applications, it may be less than optimal. Specifically, the orifice disclosed in the '086 patent merely provides a venturi effect to funnel exhaust at a consistent pressure for a single flow rate and cannot itself provide variable flow restriction.

The disclosed exhaust system is directed to overcoming one or more of the problems set forth above and/or other problems of the prior art.

### SUMMARY

In one aspect, the disclosure is directed toward a fluid valve for an exhaust system of an engine. The fluid valve may include a body and an inlet formed within the body. The inlet may have a curved first end surface with a raised convex first opening. Opposite the inlet, the fluid valve may also include an outlet formed within the body. The outlet may have a second end surface with a second opening. The fluid valve may also include a restriction formed between the first end surface and the second end surface that connects the first and second openings.

In another aspect, the disclosure is directed toward a method of regulating a fluid flow within an exhaust system for an engine. The method may include directing a flow of fluid through an inlet of a valve. The method may also include directing the flow of fluid through an outlet of the valve. The method may further include selectively redirecting a varying amount of the flow of fluid from the inlet back toward the inlet to vary a restriction on the flow of fluid from the inlet to the outlet.

### BRIEF DESCRIPTION OF THE DRAWINGS

FIG. 1 is a diagrammatic illustration of an exemplary disclosed power system; and

FIG. 2 is a cross-sectional illustration of a valve that may be used with the power system of FIG. 1.

### DETAILED DESCRIPTION

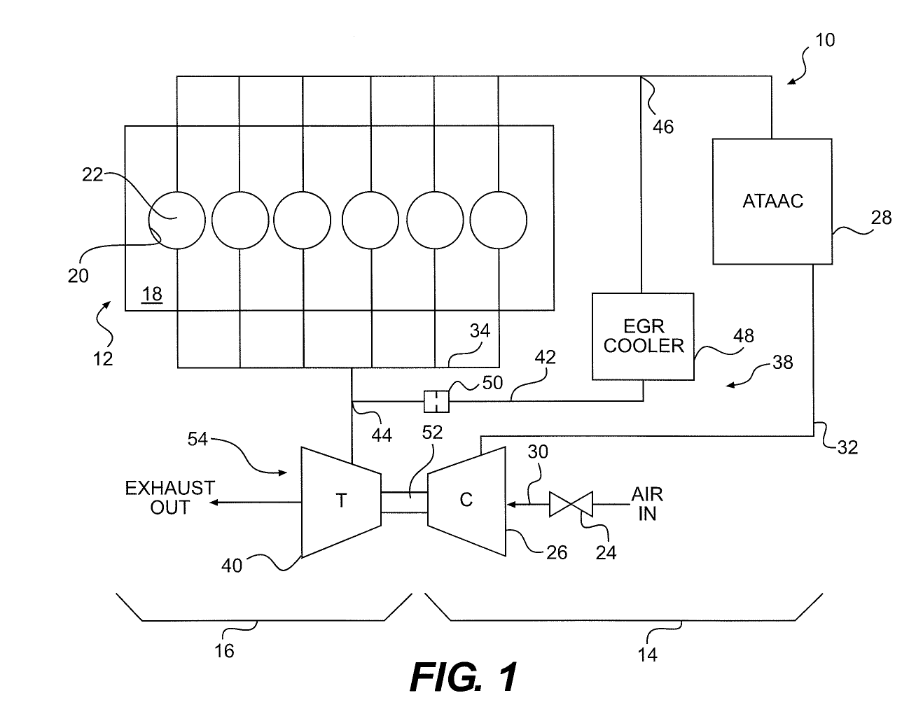

FIG. 1 illustrates a power system 10 having a power source 12, an air induction system 14 configured to direct air into power source 12, and an exhaust system 16 configured to direct exhaust away from power source 12. For the purposes of this disclosure, power source 12 is depicted and described as a diesel engine. One skilled in the art will recognize, however, that power source 12 may be any other type of combustion engine such as, for example, a gasoline or a gaseous fuel-powered engine. Power source 12 may include an engine block 18 that at least partially defines a plurality of cylinders 20. A piston (not shown) may be slidably disposed within each cylinder 20 to reciprocate between a top-dead-center position and a bottom-dead-center position, and a cylinder head (not shown) may be associated with each cylinder 20. Cylinder 20, the piston, and the cylinder head may form a combustion chamber 22. In the illustrated embodiment, power source 12 includes six such combustion chambers 22. However, it is contemplated that power source 12 may include a greater or lesser number of combustion chambers 22 and that combustion chambers 22 may be disposed in an “in-line” configuration, a “V” configuration, or in any other suitable configuration.

In one embodiment, power source 12 may be a four stroke engine. That is, for each complete engine cycle (e.g., for every two full crankshaft rotations), each piston within each cylinder 20 may move through an intake stroke, a compression stroke, a combustion or power stroke, and an exhaust stroke. As such, during each complete cycle, for the depicted six cylinder engine, there may be six strokes during which air is drawn into individual combustion chambers 22 from air induction system 14, and six strokes during which exhaust is expelled from individual combustion chambers 22 to exhaust system 16. When examining fluid flow through air induction and exhaust systems 14, 16, these strokes may correspond with pulsations of air and exhaust within the respective systems.

Air induction system 14 may include components configured to introduce charged air into power source 12. For example, air induction system 14 may include an induction valve 24, one or more compressors 26, and an air cooler 28. Induction valve 24 may be connected upstream of compressor 26 via a fluid passage 30 and configured to regulate a flow of atmospheric air to power source 12. Compressor 26 may embody a fixed or variable geometry compressor configured to receive air from induction valve 24 and compress the air to a predetermined pressure level before the air enters power source 12. Compressor 26 may be connected to power source 12 via a fluid passage 32. Air cooler 28 may be disposed within fluid passage 32, between power source 12 and compressor 26, and embody, for example, an air-to-air heat exchanger, an air-to-liquid heat exchanger, or a combination of both to facilitate the transfer of thermal energy to or from the compressed air directed into power source 12.

Exhaust system 16 may include components configured to direct exhaust from power source 12 to the atmosphere. Specifically, exhaust system 16 may include an exhaust manifold 34 in fluid communication with combustion chambers 22, an exhaust gas recirculation (“EGR”) circuit 38 fluidly communicating exhaust manifold 34 with air induction system 14, and a turbine 40 in fluid communication with exhaust manifold 34 and located downstream of EGR circuit 38. It is contemplated that exhaust system 16 may include components in addition to those listed above such as, for example, oxidizers (DOC), particulate removing devices (DPF, CDPF), constituent absorbers or reducers (SCR, AMOX, LNT), attenuation devices (mufflers), controllers, etc., if desired.

Exhaust produced during the combustion process within combustion chambers 22 may exit power source 12 via exhaust manifold 34. Exhaust manifold 34 may fluidly connect combustion chambers 22 to turbine 40. Alternatively, it is contemplated that multiple exhaust manifolds may each connect a subset of combustion chambers 22 with one or more turbines 40, if desired. For instance, a first subset of combustion chambers 22 may be in fluid communication with a first exhaust manifold, and configured to direct exhaust flow to EGR circuit 38 and/or turbine 40. In this configuration, a second subset of combustion chambers 22 may be in fluid communication with a second exhaust manifold (not shown), and configured to direct exhaust flow to only turbine 40. In such an embodiment, the first subset of combustion chambers 22 may be known as donor cylinders.

Turbine 40 may be a fixed or variable geometry turbine configured to drive compressor 26. For example, turbine 40 may be directly and mechanically connected to compressor 26 by way of a shaft 52 to form a turbocharger 54. As the hot exhaust gases exiting power source 12 move through turbine 40 and expand against blades (not shown) therein, turbine 40 may rotate and drive the connected compressor 26 to pressurize inlet air. It is contemplated that, instead of a single turbine, multiple turbines, multiple turbochargers, or a single turbine having multiple volutes may alternatively be implemented, if desired. Further, in a system using multiple exhaust manifolds, a balance valve (not shown) may be used to regulate a pressure of exhaust flowing through the different exhaust manifolds and, subsequently multiple turbines or multiple volutes of a turbine, by selectively allowing exhaust to flow from one exhaust manifold to another.

EGR circuit 38 may include components that cooperate to redirect a portion of the exhaust produced by power source 12 from exhaust manifold 34 to air induction system 14. Specifically, EGR circuit 38 may include a fluid passage 42 having an inlet port 44 located at an upstream end, an outlet port 46 and located at an opposing downstream end, a recirculation valve 50 disposed within fluid passage 42 between inlet and outlet ports 44, 46, and an EGR cooler 48 located within fluid passage 42 at a location upstream (shown) or downstream (not shown) of recirculation valve 50. Inlet port 44 may be fluidly connected to exhaust manifold 34 upstream of turbine 40, while outlet port 46 may discharge exhaust into air induction system 14 at a location upstream or downstream of air cooler 28. From its position within fluid passage 42, recirculation valve 50 may be configured to restrict a varying flow of recirculated exhaust through fluid passage 42 and thereby simultaneously vary a flow of exhaust to turbine 40. It is contemplated that recirculation valve 50 could alternatively be disposed within exhaust system 16 at a location downstream of inlet 44 (e.g., downstream of turbine 40), if desired. In this alternative location, recirculation valve may be configured to directly restrict a varying flow of exhaust into turbine 40, thereby simultaneously varying a flow of exhaust through fluid passage 42.

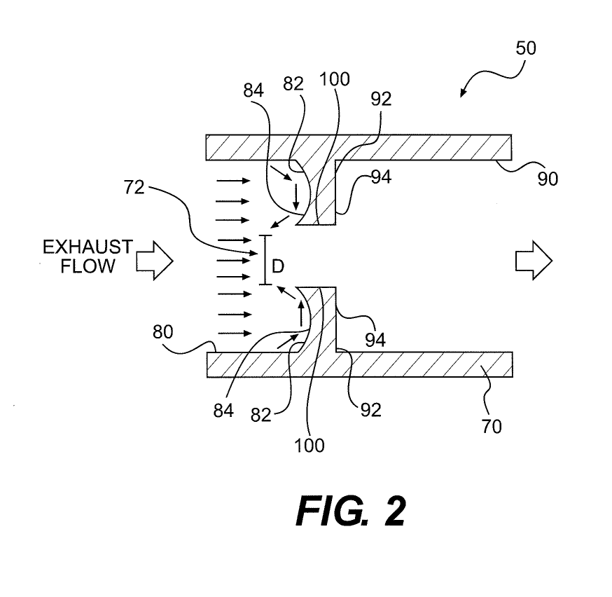

FIG. 2 shows an exemplary cross-section of recirculation valve 50. Recirculation valve 50 may include a body 70 having a flow path 72 formed therein. Flow path 72 may include an inlet 80 and an outlet 90. When recirculation valve 50 is disposed within fluid passage 42, the exhaust flow may be directed from inlet port 44 of fluid passage 42, through inlet 80 and outlet 90, before it reaches outlet port 46. The exhaust may pass through EGR cooler 48 before or after passing through recirculation valve 50. Alternatively, when recirculation valve 50 is disposed within exhaust system 16 downstream of inlet 44, the exhaust may be directed from exhaust manifold 34, through inlet 80 and outlet 90, before or after it reaches turbine 40.

Inlet 80 may have a curved first end surface 82 with a raised convex first opening 84. First end surface 82 may redirect a portion of the exhaust flow entering inlet 80 from exhaust manifold 34 back towards inlet 80. That is, the exhaust flow entering inlet 80 may strike against first end surface 82, causing the exhaust flow to follow the curvature thereof radially inward and be directed axially back the direction it came. In one embodiment, first end surface 82 may be generally spherical and the curvature may cause a redirection of flow of about 120-180°. In such an embodiment, the radius of curvature of first end surface 82 may be about 30-50 mm. Inlet 80 may have a diameter of about 150 mm, which may expand as it approaches first opening 84. For instance, the diameter of inlet 80 may be about 180 mm adjacent first opening 84. The increasing diameter of inlet 80 at first end surface 82 may provide a smooth curving transition for exhaust impinging against first end surface 82, thereby helping to maintain a generally laminar reversing flow, as opposed to a flow that bluntly engages and then ricochets off of first end surface 82 in turbulence. It is contemplated that the diameter of inlet 80 may alternatively remain constant, if desired.

Outlet 90 may have a second end surface 92 located opposite of first end surface 82, with a second opening 94 in communication with first opening 84. Outlet 90 may have a diameter of about 180 mm, which may remain substantially constant throughout outlet 90 and provide for ease of manufacture. It is contemplated, however, that outlet 90 could alternatively have a tapering diameter, if desired. Second end surface 92 may be generally flat and perpendicular to a flow direction from inlet 80 to outlet 90, which may also provide for ease of manufacture. Outlet 90 may be generally aligned with inlet 80.

Body 70 may include a restriction 100 formed between first end surface 82 and second end surface 92. Restriction 100 may connect first opening 84 and second opening 94, and function to restrict exhaust flow within recirculation valve 50. Restriction 100 may have an axial length of about 20-25 mm between first opening 84 and second opening 94, allowing for sufficient strength at the recessed curvature of first end surface 82. First and second openings 84, 94 may be generally aligned with each other and with restriction 100, though other configurations are contemplated.

Recirculation valve 50 may generate a back pressure within fluid passage 42, thereby diverting exhaust flow away from recirculation valve 50 and toward turbine 40. Despite this back pressure, some exhaust flow may always travel through flow path 72, through restriction 100, and through outlet 90.

### INDUSTRIAL APPLICABILITY

The disclosed exhaust gas recirculation (“EGR”) system may be implemented into any power system application where exhaust gas recirculation is utilized. The disclosed EGR system may offer improved control of recirculated exhaust gas in applications where variable amounts of exhaust gas recirculation are appropriate. Specifically, the disclosed EGR system may employ recirculation valve 50 to variably redirect exhaust flow for changing environmental conditions and power system optimization goals. Operation of power system 10 will now be described.

During operation of power system 10, air or a mixture of air and fuel may be pressurized, cooled, and directed into cylinders 20 for subsequent combustion. Combustion of the air/fuel mixture may result in mechanical power being generated and directed from power system 10 by way of a rotating crankshaft. Byproducts of combustion, namely exhaust and heat, may flow from power system 10 through turbine 40 to the atmosphere.

A portion of the exhaust and heat produced by power system 10 may also be selectively recirculated from exhaust system 16 into air induction system 14 for subsequent re-combustion within power system 10. This exhaust may flow from exhaust manifold 34 through inlet 44, recirculation valve 50, EGR cooler 48, and outlet 46 into fluid passage 32. As the exhaust passes through EGR cooler 48, EGR cooler 48 may cool the exhaust before the exhaust mixes with compressed air from compressor 26. The chilled and compressed mixture may then enter combustion chambers 22, along with fuel, for subsequent combustion. The recirculation of exhaust may help dilute the mixture of fuel and air, and increase the thermal mass within combustion chambers 22, resulting in a lower combustion temperature and a decreased rate of NOx formation.

Recirculation valve 50 may provide for control over the rate of exhaust gas recirculation under varying engine operating conditions. In particular, as shown in FIG. 2, recirculation valve 50 (and more particularly restriction 100) may have an effective diameter D that varies during the different operating conditions of power system 10. For the purposes of this disclosure, the effective diameter D may be defined as the diameter of the flow of exhaust passing into and through restriction 100. When flow rates, velocities, and pressures of exhaust entering recirculation valve 50 are relatively low (e.g., during operation of power system 10 at about 20% or less of rated power), the effective diameter D may be about the same as the physical diameter of restriction 100. However, as the flow rates, velocities, and/or pressures of exhaust entering recirculation valve 50 increase, the effective diameter D may decrease due to an increasing amount of exhaust flowing around end surface 82 and back in the general direction of inlet 44. That is, the radially-inward curving exhaust flow may enter into a peripheral space normally occupied by exhaust passing all the way through restriction 100. And, as the flow rates, velocities, and/or pressures increase, the curving exhaust flow may protrude further radially inward (i.e., higher velocity exhaust flows may rebound to shallower angles less than 180 degrees). This inward protrusion limits the radial space allowed for exhaust flowing through restriction 100. Because the effective diameter D may vary, the percentage of exhaust recirculated within power system 10 at higher engine speeds may decrease, as compared to exhaust flow through a conventional fixed orifice plate having a constant effective diameter.

In one example, power system 10 may operate to support a locomotive running at about 87% of rated power and release exhaust a pressure of about 5 bar from exhaust manifold 34 at about 4.7 kg/sec. The exhaust flow entering fluid passage 42 upstream of recirculation valve 50 may have a pressure of about 5 bar (i.e., an increased pressure due to restriction 100), while the exhaust flow in fluid passage 42 downstream of recirculation valve 50 may have a pressure of about 4.85 bar, resulting in a pressure differential of about 0.15 bar. It is contemplated that the pressure drop for this engine speed may vary by about 0.1-0.2 bar. In this example, recirculation valve 50 may have an effective diameter of about 100 mm and pass about 27% of the total exhaust flow from power source 12 through fluid passage 42 to air induction system 14. That is, the curvature at first end surface 82 may cause a redirection of air that effectively shrinks the effective diameter of the allowed flow path 72 of air through restriction 100 from about 150 mm to about 100 mm.

In another example, power system 10 may operate to support a locomotive running at about 13% of rated power and release exhaust at about 1.532 bar from exhaust manifold 34 at about 1.086 kg/sec. The exhaust flow entering fluid passage 42 upstream of recirculation valve 50 may have a pressure of about 1.53 bar, while the exhaust flow in fluid passage 42 downstream of recirculation valve may have a pressure of about 1.5 bar, resulting in a pressure differential of about 0.03 bar. In this example, recirculation valve 50 may pass about 21% of the total exhaust flow from power source 12 through fluid passage 42 to air induction system 14 and have an effective diameter of about 120 mm. Accordingly, recirculation valve 50 may be sized to increase its effective diameter at lower operating levels and decrease its effective diameter at higher operating levels of power system 10. That is, recirculation valve 50 may pass a greater amount of exhaust through EGR circuit 38 at the lower operating levels (and/or a lower amount at higher operating levels) as compared to a conventional fixed diameter orifice plate.

Many advantages may be associated with recirculation valve 50. In particular, by being fixed, recirculation valve 50 may be reliable because it does not depend on a controller for adjustment. In addition, by not including moving parts, recirculation valve 50 may also be more robust. Further, recirculation valve 50 may generate a restriction that is variable, thereby improving the performance of power system 10.

It will be apparent to those skilled in the art that various modifications and variations can be made to the system of the present disclosure. Other embodiments of the system will be apparent to those skilled in the art from consideration of the specification and practice of the method and system disclosed herein. It is intended that the specification and examples be considered as exemplary only, with a true scope of the disclosure being indicated by the following claims and their equivalents.

What is claimed is:

1. A fluid valve, comprising:
a body;
an inlet formed within the body and having a curved first end surface with a raised convex first opening;
an outlet formed within the body, opposite the inlet, and having a second end surface with a second opening; and
a restriction formed between the first end surface and the second end surface and connecting the first and second openings.

2. The fluid valve of claim 1, wherein the second end surface is generally flat and perpendicular to a flow of fluid from the inlet to the outlet.

3. The fluid valve of claim 1, wherein the first end surface is generally spherical.

4. The fluid valve of claim 1, wherein geometry of the fluid valve remains fixed throughout operation of the fluid valve.

5. The fluid valve of claim 4, wherein an effective flow diameter of the fluid valve varies as a function of a flow parameter of exhaust passing through the fluid valve.

6. The fluid valve of claim 5, wherein:
for a flow rate of about 1.086 kg/sec, the effective flow diameter of the fluid valve is about 120 mm; and
for a flow rate of about 4.7 kg/sec, the effective flow diameter of the fluid valve is about 100 mm.

7. The fluid valve of claim 2, wherein:
fluid passing through the fluid valve at a flow rate of about 1.086 kg/sec generates a pressure drop across the restriction of about 0.025 to 0.035 bar; and
fluid passing through the fluid valve at a flow rate of about 4.7 kg/sec generates a pressure drop across the restriction of about 0.1 to 0.2 bar.

8. The fluid valve of claim 1, wherein the first end surface has a radius of curvature of about 30 to 50 mm.

9. The fluid valve of claim 1, wherein the inlet has a diameter of about 150 mm.

10. The fluid valve of claim 9, wherein the inlet tapers outward toward restriction and has a diameter of about 180 mm adjacent the first opening.

11. The fluid valve of claim 10, wherein the outlet has a diameter of about 180 mm and remains substantially constant along its length.

12. A method for regulating a fluid flow, comprising:
directing a flow of fluid through an inlet of a valve;
directing the flow of fluid through an outlet of the valve; and
selectively redirecting a varying amount of the flow of fluid from the inlet back toward the inlet to vary a restriction on the flow of fluid from the inlet to the outlet.

13. The method of claim 12, wherein the flow of fluid is a flow of exhaust generated by an engine.

14. The method of claim 13, wherein directing the flow of fluid through the inlet of the valve includes:
directing about 21% of a total exhaust flow from the engine through the inlet of the valve and back into the engine for a given total exhaust flow of about 1.086 kg/sec; and
directing about 27% of a total exhaust flow from the engine through the inlet of the valve and back into the engine for a given total exhaust flow of about 4.7 kg/sec.

15. The method of claim 14, wherein, for the given total exhaust flow rate of about 1.086 kg/sec, directing the flow of fluid through the inlet of the valve includes generating a pressure drop across the valve of about 0.03 bar.

16. The method of claim 13, wherein, for the given total exhaust flow rate of about 4.7 kg/sec, directing the flow of fluid through the inlet of the valve includes generating a pressure drop across the valve of about 0.15 bar.

17. The method of claim 13, wherein selectively redirecting a varying amount of the flow of exhaust includes selectively reducing an effective flow diameter of the valve as a rate of exhaust flow from the engine increases.

18. The method of claim 17, wherein:
the valve has a physical diameter of about 150 mm; and
selectively reducing the effective flow diameter includes selectively reducing the effective flow diameter from about 150 mm to about 120 mm for a given rate of exhaust flow of about 1.086 kg/sec.

19. The method of claim 17, wherein:
the valve has a physical diameter of about 150 mm; and
selectively reducing the effective flow diameter includes selectively reducing the effective flow diameter from about 150 mm to about 100 mm for a given rate of exhaust flow of about 4.7 kg/sec.

20. An exhaust system for an engine, comprising:
an intake manifold configured to direct air into the engine;
an exhaust manifold configured to receive exhaust away from the engine;
a turbocharger having a turbine fluidly connected to the exhaust manifold and a compressor fluidly connected to the intake manifold;
an EGR passage in communication with the exhaust manifold and the intake manifold; and
a valve disposed in the EGR passage and having:
a body;
an inlet formed within the body and having a spherical first end surface with a raised convex first opening;
an outlet formed within the body, opposite the inlet, and having a second end surface with a second opening, wherein the second end surface is generally flat and perpendicular to the first end surface; and
a restriction formed between the first end surface and the second end surface and connecting the first and second openings,
wherein:
the inlet of the valve has a diameter of about 150 mm that tapers outward toward the restriction;
the outlet of the valve has a diameter of about 180 mm that remains generally constant along its length; and
the first end surface of the fixed fluid valve has a radius of curvature of about 30-50 mm.
